(19) United States
(12) Patent Application Publication
(10) Pub. No.: US 2026/0061742 A1
(43) Pub. Date: Mar. 5, 2026

(54) LIQUID EJECTION HEAD

(71) Applicant: CANON KABUSHIKI KAISHA, Tokyo (JP)

(72) Inventors: TAKASHI KATO, Kanagawa (JP); YOSHIYUKI NAKAGAWA, Kanagawa (JP)

(21) Appl. No.: 19/309,236

(22) Filed: Aug. 25, 2025

(30) Foreign Application Priority Data
Aug. 30, 2024 (JP) 2024-150032

(51) Int. Cl. B41J 2/045; B41J 2/175; B41J 2/21

(52) U.S. Cl. CPC B41J 2/04541; B41J 2/04543; B41J 2/0455; B41J 2/17523; B41J 2/2103; B41J 2/0458; B41J 2202/12

(57) ABSTRACT

A liquid ejection head includes an individual ejection unit including an ejection port, a pressure chamber, a first energy generating element that ejects liquid from the ejection port, an individual flow path communicating with the pressure chamber, and a second energy generating element provided in the individual flow path; and a common flow path for supplying the liquid to the individual flow path of the individual ejection unit. When the first energy generating element is driven, the second energy generating element is not driven. When the first energy generating element is not driven, the second energy generating element is driven only when receiving a drive instruction signal for the second energy generating element.

### BACKGROUND

### Field of the Technology

The present disclosure relates to a liquid ejection head.

### Description of the Related Art

There is a known circulating-type liquid ejection device that circulates ink to discharge bubbles in a flow path and prevent an increase in viscosity of the ink in the vicinity of an ejection port in a liquid ejection head (hereinafter also referred to as the “head”). A well-known method for circulating ink is a method utilizing a pressure difference (this method will be hereinafter also referred to as the “differential pressure method”. By this method, the pressure on the side (inner side) of ink supply to the ejection port is made higher than the pressure on the side (outer side) of ink recovery, so that the ink is made to flow from the inner side toward the outer side. At this point of time, to circulate the ink, it is necessary to return the ink that has flowed to the outer side to the inner side, and a pump is required as a mechanism for that purpose. Note that a pump may be provided outside the head of the recording device main body to circulate the liquid between a liquid ejection head and the main body, or a pump may be provided inside the liquid ejection head to circulate the liquid in the liquid ejection head. However, such a differential-pressure circulation method requires mechanisms such as a pressure adjusting mechanism and a pump, and therefore, the recording device main body and the head easily become larger in size.

In view of this, an ink circulation method other than the differential-pressure method has been studied. Specifically, there is a known mechanism that circulates ink in a circulating flow path by providing the circulating flow path communicating with an ejection port, and disposing an energy generating element (also referred to as a “flow energy generating element”) different from an energy generating element (also referred to as an “ejection energy generating element”) for ejecting ink in the circulating flow path, and moreover driving the flow energy generating element.

Japanese Patent Application Publication No. 2020-104312 discloses a configuration in which a circulating flow path extending to intersect an ejection port row, in which a plurality of ejection ports is arranged, is provided, and a flow energy generating element is provided in the circulating flow path.

### SUMMARY

According to some embodiments of the present disclosure, a liquid ejection head includes an individual ejection unit including an ejection port for ejecting a liquid, a pressure chamber communicating with the ejection port, a first energy generating element provided in the pressure chamber, and generating energy for ejecting the liquid from the ejection port, an individual flow path communicating with the pressure chamber, and a second energy generating element provided in the individual flow path; and a common flow path for supplying the liquid to the individual flow paths of a plurality of the individual ejection units, wherein when the first energy generating element is driven, the second energy generating element is not driven, and, when the first energy generating element is not driven, the second energy generating element is driven only after receiving a drive signal for issuing an instruction to drive the second energy generating element.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are overall views of devices each using a liquid ejection head.

FIGS. 2A to 2D are an overall view of a liquid ejection head and overall views of liquid ejection chips.

FIGS. 3A to 3D are schematic views of the vicinities of ejection ports of a liquid ejection head.

FIGS. 4A to 4C are schematic views of the vicinities of ejection ports of a liquid ejection head.

FIGS. 5A to 5D are schematic views of the vicinities of ejection ports of a liquid ejection head.

FIGS. 6A to 6D are schematic views of the vicinities of ejection ports of a liquid ejection head.

FIGS. 7A to 7C are schematic views of the vicinities of ejection ports of a liquid ejection head according to a first embodiment.

FIG. 8 is a circuit configuration diagram of a comparative configuration.

FIG. 9 is a first circuit configuration diagram according to the first embodiment.

FIG. 10 is a second circuit configuration diagram according to the first embodiment.

FIG. 11 is a third circuit configuration diagram according to the first embodiment.

FIGS. 12A to 12C are schematic views of the vicinities of ejection ports of a liquid ejection head according to a second embodiment.

FIGS. 13A to 13C are schematic views of the vicinities of ejection ports of a liquid ejection head according to a third embodiment.

FIGS. 14A and 14B are schematic views of the vicinities of ejection ports of a liquid ejection head according to a fourth embodiment.

FIGS. 15A and 15B are schematic views of the vicinities of ejection ports of a liquid ejection head according to a fifth embodiment.

FIGS. 16A to 16C are schematic views of the vicinities of ejection ports of a liquid ejection head according to a sixth embodiment.

### DESCRIPTION OF THE EMBODIMENTS

In the following, various exemplary embodiments, features, and aspects of the present disclosure will be described in detail with reference to the accompanying drawings. Note that the following embodiments do not limit the subject matter of the present disclosure, and not all of the combinations of features described in the embodiments are necessarily essential to the solution according to the present disclosure. The same components are denoted by the same reference numerals. In the description below, a basic configuration according to the present disclosure is first explained, followed by explanation of characteristic components according to the present disclosure.

According to studies of the inventors, there are no disclosures regarding what kind of drive data is used to drive an ejection energy generating element and a flow energy generating element in a conventional configuration. It is normally conceivable to provide drive data to each energy generating element, but the amount of data increases with the number of energy generating elements.

Therefore, it is advantageous and beneficial to provide a technology for optimizing the amount of drive data in an ink-circulating liquid ejection head using both an ejection energy generating element and a flow energy generating element.

### Liquid Ejection Device

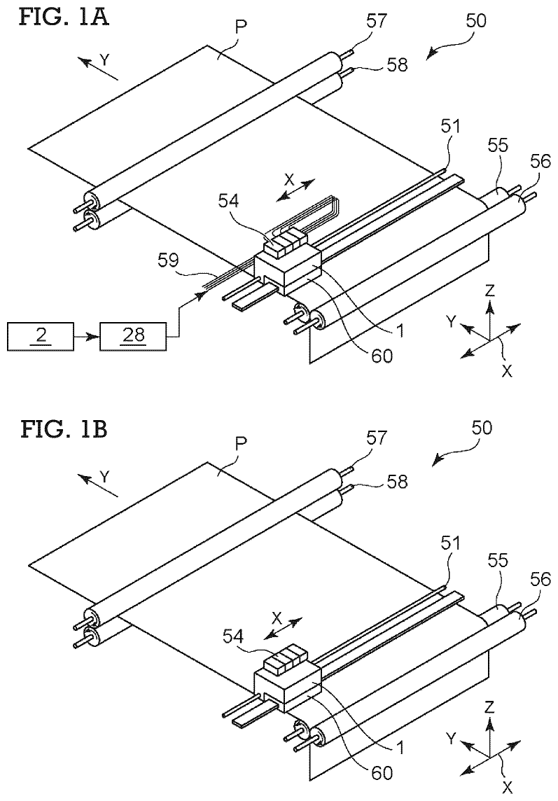

First, a schematic configuration of a liquid ejection device 50 in this embodiment is described. FIGS. 1A and 1B are enlarged views of a liquid ejection head 1 of the liquid ejection device 50 and its periphery, and FIGS. 1A and 1B are schematic perspective views of the liquid ejection device that uses the liquid ejection head. The liquid ejection device 50 shown in FIGS. 1A and 1B is a liquid ejection device (a serial liquid ejection device) that is designed to perform image recording by ejecting a liquid onto a recording medium P with a liquid ejection head that performs scanning in a direction intersecting the direction of transport of the recording medium P. The present disclosure is not limited to a serial liquid ejection device, but can also be applied to a page-wide liquid ejection device that performs image recording by ejecting a liquid onto a recording medium being transported in the transport direction, using a line head (a page-wide head) long in the page width direction of the recording medium. Note that the liquid ejection head in this embodiment can eject the four types of ink, which are black (K), cyan (C), magenta (M), and yellow (Y), and a full-color image can be recorded with these inks. The inks that can be ejected from the liquid ejection head are not limited to the above four types of ink. The present disclosure can also be applied to liquid ejection heads for ejecting other types of ink. That is, the types and the number of inks to be ejected from the liquid ejection head are not limited to any particular types and number.

In the serial liquid ejection device 50, the liquid ejection head 1 is mounted on a carriage 60. The carriage 60 moves back and forth along a guide shaft 51 in a main scanning direction (X direction). The recording medium is transported by transport rollers (transport means) 55, 56, 57, and 58 in a sub scanning direction (Y direction) that intersects with (in this example, is orthogonal to) the main scanning direction. In each of the drawings to be referred to in the description below, the Z direction indicates the vertical direction, and intersects with (in this example, is orthogonal to) the X-Y plane defined by the X direction and the Y direction.

FIG. 1A illustrates a configuration in which a main ink tank 2 as a liquid reservoir is provided outside the liquid ejection head. The liquid (ink) stored in the ink tank 2 is supplied to a sub ink tank 54 on the side of the liquid ejection head 1 via an ink supply tube (liquid communication path) 59 or the like by a driving force of an external pump 28. On the other hand, FIG. 1B illustrates a configuration in which the ink tank 54 is provided immediately above the liquid ejection head 1 (without the main ink tank 2 as a liquid reservoir outside the liquid ejection head). At this point of time, the liquid ejection head 1 is formed integrally with the ink tank 54 and can be attached to and detached from the carriage 60 in some cases. In other cases, however, the liquid ejection head 1 is formed integrally with the carriage 60, and only the ink tank 54 can be attached to and detached from the carriage 60. In the description below, the configuration illustrated in FIG. 1A is used as a representative example.

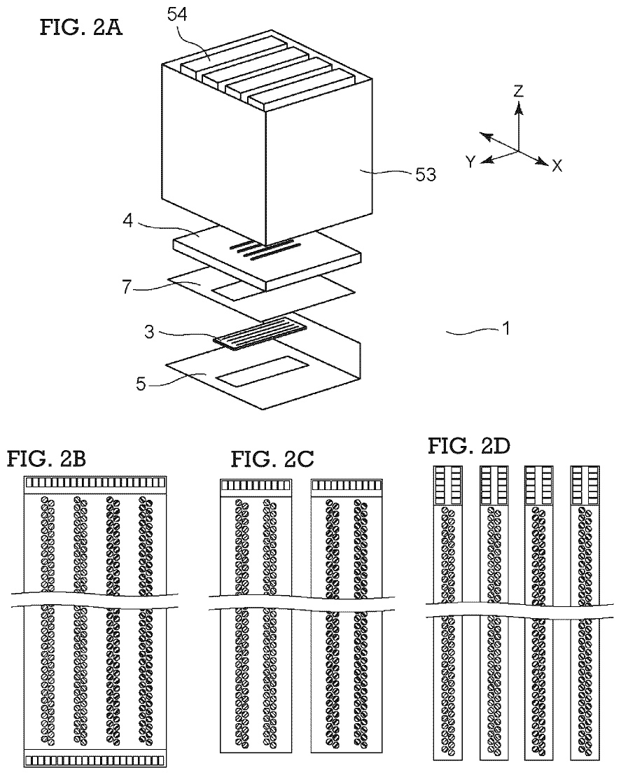

The liquid ejection head 1 includes individual ejection units described later (see FIGS. 2A to 2D). Although a specific configuration will be described later, an individual ejection unit includes an ejection port for ejecting a liquid, a pressure chamber communicating with the ejection port, a first energy generating element (ejection energy generating element) that is provided in the pressure chamber and generates energy for ejecting the liquid from the ejection port, an individual flow path communicating with the pressure chamber, and a second energy generating element (flow energy generating element) provided in the individual flow path. The liquid ejection head 1 includes a plurality of individual ejection units, and has a supply flow path for supplying the liquid to the individual flow path in each individual ejection unit.

When a liquid ejection head is used, there are cases where the liquid ejection becomes unstable due to evaporation of volatile components such as moisture from the ejection port or the accompanying concentration of solids in the vicinity of the ejection port. To prevent this, a variety of devices have been devised. For example, a cap member (not shown) can be provided in a liquid ejection device that can cover the ejection port surface of the liquid ejection head where the ejection port is formed, at a position that is away from the recording medium conveying path in the X direction. The cap member is used to cover the ejection port surface of the liquid ejection head and prevent the ejection port from drying or protecting the ejection port when any recording operation is not being performed. Further, an ink suction mechanism (not shown) may be provided, and, in that case, the cap member is used for ink suction from the ejection port. As this ink suction operation is performed, the ink near the ejection port is refreshed, and the quality of the obtained image quality can be maintained. There also are known methods including a method for discarding concentrated ink by performing ejection called preliminary ejection (pre-ejection) when any recording operation is not being performed, and a method for performing preliminary ejection (paper surface preliminary ejection/in-page preliminary ejection) of ink at a position and in an amount that are not noticeable in terms of image quality on the recording medium even during a recording operation. Although these methods greatly contribute to increases in image quality, it is desirable to reduce the amount of waste ink as much as possible, because some of the ink is discarded to refresh the ejection port.

To solve such a problem, the second energy generating element (flow energy generating element) is provided in the individual flow path to circulate the ink in the flow path, so that drying of the ejection port and concentration of the ink near the ejection port can be reduced while the amount of waste ink is reduced. More specifically, the number of times preliminary ejection or suction recovery is performed can be reduced as much as possible. Further, if the number of times preliminary ejection or the like can be minimized, the throughput and yield can also be improved.

The second energy generating element (flow energy generating element) is not necessarily provided in all the individual ejection units of the liquid ejection head. In a case where the second energy generating element is provided in some of the individual ejection units, the above-described effect can be achieved more effectively than in a case where no second energy generating elements are provided.

Also, the liquid ejection head shown in FIG. 1A may have a configuration in which all parts corresponding to the four types of ink have the second energy generating element, or only the part corresponding to one type of ink has the second energy generating element. That is, the liquid ejection head may be designed to circulate not all the four types of ink, but only at least one type of ink.

### Basic Configuration of Liquid Ejection Head

FIG. 2A is an exploded perspective view of the liquid ejection head of this embodiment. As shown in FIGS. 2A to 2D, the liquid ejection head includes the sub ink tank 54 that temporarily stores ink in the head, and a liquid ejection chip 3 for ejecting the ink supplied from the sub ink tank 54 to the recording medium P. The liquid ejection head in this embodiment is fixed and supported on the carriage by a positioning means (not shown) and electrical contacts provided on the carriage of the liquid ejection device. The liquid ejection head ejects the ink while moving in the main scanning direction (X direction) shown in FIGS. 1A and 1B together with the carriage, and performs recording on the recording medium P.

The external pump 28 connected to the ink tank 2 serving as the ink supply source has the ink supply tube 59 (see FIG. 1A). A liquid connector (not shown) is provided at the end of the ink supply tube. When the liquid ejection head 1 is mounted on the liquid ejection device 50, the liquid connector provided at the end of the ink supply tube 59 is liquid-tightly connected to a liquid connector insertion port that is a liquid introduction port provided in the head housing of the liquid ejection head 1. As a result, an ink supply path is formed from the ink tank 2 to the liquid ejection head 1 via the external pump 28. Since the four types of ink are used in this embodiment, four sets of the ink tank 2, the external pump 28, the ink supply tube 59, and the sub ink tank 54 are provided for the respective inks, and four ink supply paths corresponding to the respective inks are formed independently of one another. In this manner, the liquid ejection device of this embodiment has an ink supply system in which ink is supplied from the ink tank 2 provided outside the liquid ejection head 1. Note that the liquid ejection device of this embodiment does not have an ink recovery system for recovering ink from the liquid ejection head and returning the ink into the ink tank. Therefore, the liquid ejection head has the liquid connector insertion port for connecting the ink supply tube of the ink tank but does not have a connector insertion port for connecting a tube for recovering ink from the liquid ejection head and returning the ink into the ink tank. Note that the liquid connector insertion port is provided for each type of ink.

FIGS. 2B, 2C, and 2D are overall views of liquid ejection chips that form liquid ejection heads. FIG. 2B shows a configuration in which one chip is provided for four colors, FIG. 2C shows a configuration in which one chip is provided for two colors, and FIG. 2D shows a configuration in which one chip is provided for one color. Each of the liquid ejection chips has an ejection port and pads to be used for electrical packaging. FIG. 2A illustrates the chip configuration shown in FIG. 2B.

FIG. 2B illustrates a first embodiment in which one chip is formed for four colors. The four colors are black, cyan, magenta, and yellow, for example, and columns are formed for the respective colors, and are arranged in the Y direction. The ejection ports of the respective columns are adjacent to one another while being shifted from one another in the X direction, and are arranged in the Y direction at equal intervals. Here, the ejection ports in the respective columns may be arranged in one row in the Y direction without being shifted from one another in the X direction. Alternatively, two columns may be provided for black, and five columns in total may be used for the four colors.

FIG. 2C illustrates a second embodiment in which one chip is formed for two colors, and two chips are used. When two chips are mounted on the liquid ejection head, two chips may be mounted on one liquid ejection head, or two liquid ejection heads each having one chip mounted thereon may be prepared.

FIG. 2D illustrates a third embodiment in which one chip is formed for one color, and four chips are used. As in FIG. 2C, four chips may be mounted on one liquid ejection head, or four liquid ejection heads each having one chip mounted thereon may be prepared.

Further, in a case where the chip is divided into a plurality of chips as in FIGS. 2C and 2D, all the chips may not have the same chip length. Furthermore, various combinations of other colors for the chips are possible, and the same applies in a case where the total number of colors is larger than four.

### Components of Circulation Unit

Straight Type

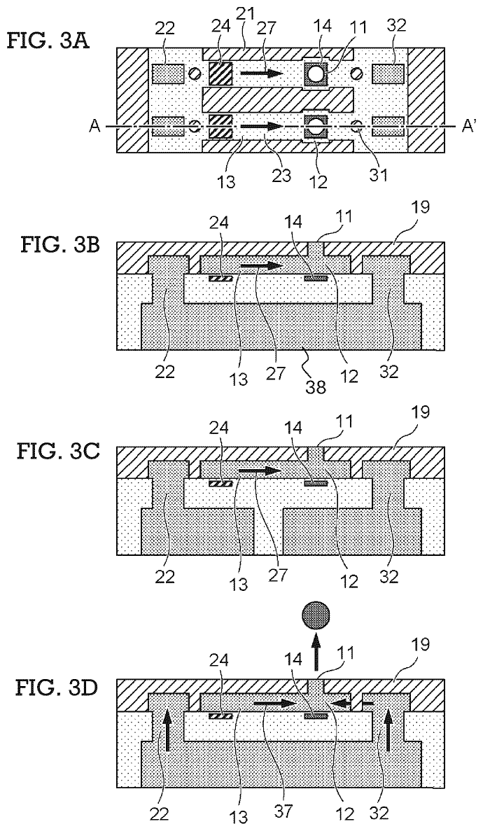

FIGS. 3A to 3D are schematic views for explaining the vicinity of the ejection port of a straight-type liquid ejection head. The “straight type” in the present specification means that the individual flow path in which the first energy generating element (ejection energy generating element) and the second energy generating element (flow energy generating element) are disposed has a straight shape extending in a direction intersecting with (in FIGS. 3A to 3D, orthogonal to) the ejection port row so that both end portions thereof are located on both sides sandwiching the ejection port row. In other words, the first energy generating element and the second energy generating element are arranged in a direction intersecting the ejection port row in the individual flow path of the individual ejection unit.

FIG. 3A is a plan view as viewed in the direction in which droplets are ejected from the ejection port. FIG. 3B is a cross-sectional view of the structure taken along the line A-A′ defined in FIG. 3A. FIG. 3C is another cross-sectional view of the structure taken along the line A-A′ defined in FIG. 3A. FIG. 3D is a diagram for explaining the ink influx in a case where the first energy generating element is driven.

In FIGS. 3A to 3C, between a substrate 18 and an orifice plate 19, pressure chambers 12 that are partitioned by partition walls 21 and correspond to the respective ejection ports 11, and individual flow paths 23 in which ink flows through the pressure chambers 12 are formed. An ink meniscus is spread on the ejection ports 11, and an ejection port interface as the interface between the ink and the atmosphere is formed.

The substrate 18 includes first energy generating elements 14 that generate energy for ejecting the ink in the pressure chambers. In this example, electro-thermal conversion elements are used. The first energy generating elements 14, together with the ejection ports 11 and the pressure chambers 12, are located closer to second supply openings 32 than to first supply openings 22. By heating and driving the first energy generating elements 14 to foam the ink in the pressure chambers 12, it is possible to eject the ink from the ejection ports 11, utilizing the foam energy. The first energy generating elements are not necessarily electro-thermal conversion elements as in this embodiment, and piezo elements or the like can be used.

The substrate 18 also includes second energy generating elements 24 that generate energy for generating a circulating flow 27 in which the ink in the individual flow paths is indicated by arrows. In this example, electro-thermal conversion elements are used. Accordingly, the second energy generating elements 24 are also referred to as circulating heaters 24.

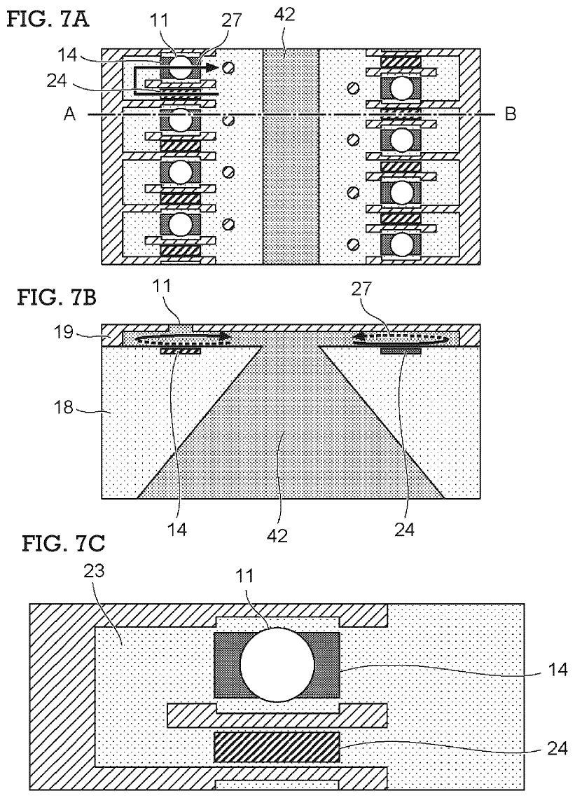

Further, the substrate 18 has an opening for supplying liquid from a common flow path to the individual flow paths. This opening may be designed to have a plurality of openings (independent supply openings) as shown in FIG. 3A, or may be a supply groove as one large opening as shown in FIG. 7A described below. The second energy generating elements 24 are located closer to the first supply openings 22 than to the second supply openings 32.

The individual flow paths 23 extend in a second direction that intersects with (in this example, orthogonal to) the direction (first direction) in which the ejection ports are aligned in a row. The individual flow paths 23 each include a pressure chamber 12, an inlet (upstream) side connection flow path 13 in FIG. 3B that communicates with one end portion of the pressure chamber 12, and an outlet (downstream) side flow path in FIG. 3B that communicates with the other end portion of the pressure chamber 12. The individual flow path 23 communicates with the first supply opening 22 and the second supply opening 32, which penetrate through the substrate 18 at one end on the upstream side and the other end on the downstream side, respectively. Accordingly, the connection flow path 13 is located closer to the second energy generating elements than to the ejection port row. Both end portions of each individual flow path 23 are located on opposite sides to each other, with the ejection port row being interposed in between. The first supply openings 22 and the second supply openings 32 are supplied with liquid from a common flow path 38.

Ink flows flowing through each individual flow path are divided into the following two: (1) a first ink flow for driving the first energy generating element 14 and performing refilling after ejection; and (2) a second ink flow for driving the second energy generating element 24 and forming a circulating flow.

In a case where the first energy generating element 14 is driven, and liquid is ejected from the ejection port 11, ink flows into the pressure chamber from both supply openings to supply the ink accompanying the ejection from the first supply opening 22 and the second supply opening 32 as shown in FIG. 3D.

In a case where the second energy generating element 24 is driven to form a circulating flow, ink flows into the individual flow path 23 through the first supply opening 22 on the connection flow path side, and flows outside through the second supply opening 32, which is not on the connection flow path side. In this example, the ink that has flowed out of the second supply opening 32 is returned to the first supply opening 22 and is circulated to form the circulating flow 27 indicated by an arrow in the individual flow path 23. Note that FIG. 3B shows a configuration in which the first supply opening 22 and the second supply opening 32 are integrated in the chip. Further, a configuration in which the first supply opening 22 and the second supply opening 32 are connected to individual flow paths and are integrated outside the recording head is shown in FIG. 3C, and either of the configurations may be used.

Filters 31 for removing foreign matter in the ink may be provided in the ink circulating flow paths inside and outside the recording head 20. In FIG. 3, the filters are disposed on the inflow side and the outflow side, which are outside the individual flow paths. Also, filters may be disposed between the first energy generating elements and the second energy generating elements in the individual flow paths. In that case, the filters may not be disposed on the upstream side (the second energy generating element side) that is the outside of the individual flow paths.

### U-Shaped Type

Referring now to FIGS. 7A to 7C regarding the first embodiment described below, the vicinity of the ejection port of a U-shaped liquid ejection head is described. “U-shaped” in the present specification means that the flow path in which the first energy generating element (ejection energy generating element) and the second energy generating element (flow energy generating element) are disposed has a U-like shape. That is, in the individual flow path, the first energy generating element and the second energy generating element are disposed along the ejection port row. Also, the individual flow path is designed so that either end portion thereof is located on one side with respect to the ejection port row. FIG. 7A is a plan view as viewed in the direction in which droplets are ejected from the ejection ports. FIG. 7B is a cross-sectional view of the structure taken along the line A-B defined in FIG. 7A. FIG. 7C is an enlarged schematic view for explaining the element names in the individual flow path portions in FIG. 7A.

In FIGS. 7A to 7C, both the first energy generating elements 14 and the second energy generating elements 24 are located near a supply groove 42. The individual flow paths 23 are formed in a shape (U-shape) in which the first energy generating elements and the second energy generating elements are arranged alternately in the direction (first direction) in which the ejection ports are arranged side by side to form a row, and which are bent so as to connect them. The individual flow paths 23 each include the pressure chamber 12, the inlet (upstream) side connection flow path 13 in FIG. 7B communicating with one end portion of the pressure chamber 12, and the outlet (downstream) side flow path in FIG. 7B communicating with the other end portion of the pressure chamber 12. The individual flow paths 23 communicate with the supply groove 42 penetrating the substrate 18 on both the upstream side and the downstream side. Both end portions of each individual flow path 23 are positioned adjacent to each other on one side of the supply groove 42.

Ink flows flowing in the individual flow paths are classified into the two, i.e., (1) the first ink flow and (2) the second ink flow, as in the straight type.

In a case where the first energy generating element 14 is driven, and liquid is ejected from the ejection port 11, ink accompanying the ejection is supplied from the supply groove 42, so that the ink flows into the pressure chamber from both the connection flow path side and the opposite side.

In a case where the second energy generating element 24 is driven to form a circulating flow, ink flows into the individual flow path 23 from the inlet (upstream) side, which is the connection flow path side, and flows out toward the outlet (downstream) side. In this example, both of the flows into and out of the common supply groove 42 are caused to form the circulating flow 27 shown by an arrow in the individual flow path 23. Although the supply groove 42 is shown in this embodiment, it may be replaced with a row of supply openings arranged in the first direction as shown in FIGS. 3A to 3D. In a case where the supply groove is replaced with supply openings, the supply openings are integrated in the chip as shown in FIG. 3B.

### Pump Principles

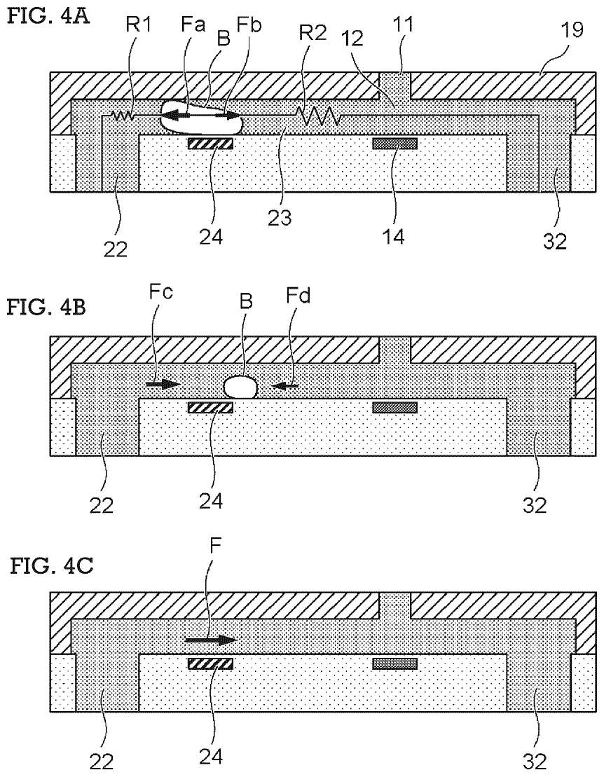

FIGS. 4A to 4C are schematic views for explaining the principles of generation of an ink circulating flow in a case where a second energy generating element (circulating heater) 24 that is an electro-thermal conversion element is used. Each of FIGS. 4A, 4B, and 4C is a cross-sectional view similar to FIG. 3B, illustrating the process of generating and growing bubbles B from film boiling of ink, the contraction process, and the post-debubbling process after the ink is heated by the circulating heater 24. In FIG. 4A, the circulating heater 24 is located closer to the first supply opening 22 than to the second supply opening 32. Accordingly, a flow resistance R1 between the circulating heater 24 and the first supply opening 22 is lower than a flow resistance R2 between the circulating heater 24 and the second supply opening 32. The structure in FIG. 4A is combined with an equivalent circuit in which such flow resistances R1 and R2 are expressed as electrical resistances. The bubbles B generated by the film boiling of the ink grow on the side of the first supply opening 22 with the low flow resistance R1 as shown in FIG. 4A, due to the difference between the flow resistances R1 and R2. Accordingly, in the individual flow path 23, the ink flow Fa toward the first supply opening 22 is greater than the ink flow Fb toward an outflow path 15.

FIG. 4B is an explanatory view of the ink flow during the process of contraction of the bubbles B. During the process of contraction of the bubbles B, ink flows in so as to compensate for the volume of the contraction. At that point of time, the ink flow Fc flowing from the first supply opening 22 on the side of the low flow resistance R1 is greater than the ink flow Fd flowing from the second supply opening 32 on the side of the high flow resistance R2, as illustrated in FIG. 4B. Further, the bubbles B disappear at a position that is closer to the second supply opening 32 from above the circulating heater 24.

FIG. 4C is an explanatory view illustrating the process of post-debubbling of the bubbles B. The relationship, Fc>Fd, caused in FIG. 4B results in a circulating flow F of ink from the first supply opening 22 toward the second supply opening 32.

The magnitude of such a circulating flow F is affected by the ratio between the flow resistances R1 and R2 and the size of the bubbles B. For example, on the assumption that the circulating heater 24, which is an electro-thermal conversion element, is used as the second energy generating element 24, it is preferable that the second energy generating element 24 is located closer to one of both end portions of the individual flow path 23 than the first energy generating element. More specifically, the flow resistance ratio R1/R2 is preferably set within the range of 0.05 to 0.40. As the flow resistance ratio R1/R2 is set within this range, the circulating flow F can be maximized. It is important for the circulating flow F to have a greater ink flow Fa flowing toward the first supply opening 22, and have a smaller ink flow Fc flowing in from the first supply opening 22 shown in FIGS. 4A and 4B. Therefore, it is effective to reduce the flow resistance R1. It is also important to minimize the ink flow Fb flowing toward the outflow path 15, and reduce the ink flow Fd flowing in from the second supply opening 32. Therefore, it is effective to increase the flow resistance R2. In view of the above, it is important to reduce the flow resistance R1 and increase the flow resistance R2, or to lower the flow resistance ratio R1/R2. Further, large bubbles B, or a large bubble volume, leads to an increase in the exclusion volume of the fluid generated in the individual flow path 23, and thus, results in a greater circulating flow F.

Means to increase the bubble volume include the followings:
Increase in the size of the circulating heater 24
Decrease in the flow resistance by increasing the width and height of the flow path 13
Decrease in ink viscosity
Increase in head temperature
Double pulsing of the drive pulse

Part of the circulating flow F of the ink enters the ejection port 11, to send the concentrated ink in the ejection port 11 to the side of the second supply opening 32, and introduce fresh ink into the ejection port 11 from the side of the first supply opening 22 through the connection flow path 13. By making the concentrated ink less likely to stay in the ejection port 11 in this manner, it is possible to reduce the influence of the concentrated ink, and maintain the initial ink ejecting state.

The circulating flow F is a transient flow accompanying the growth and contraction processes when the bubbles B are generated. Therefore, the inertial flow of the bubbles B after debubbling becomes weaker over time, and stops after a certain period of time. In view of this, to generate the circulating flow F steadily for a certain period of time, it is possible to repeatedly drive the heating element of the circulating heater 24. The cycles of driving of the circulating heater 24 are not limited to any particular cycles, as long as the concentrated ink in the ejection port 11 can be discharged. However, since the flow is a transient flow accompanying the growth process and the contraction process at the time of generation of the bubbles B, the effect is smaller in a case where driving is performed at a high drive frequency such as 100 kHz, by taking into account the cycle of 10 μs, which is the time from the bubble generation to the debubbling. Therefore, it is preferable to drive the circulating heater 24 in cycles of about 100 Hz to tens of kHz, for example, and the circulating flow F is maintained more effectively at a higher drive frequency. Thus, the effect of discharging the concentrated ink is enhanced. On the other hand, it is possible to take into consideration the rise in the temperature of the ink due to the heat generated by the driving of the circulating heater 24. Therefore, the number of times the circulating heater 24 is driven may be appropriately controlled.

Note that it is conceivable that the second energy generating element that contributes to circulation has a lower driving energy than the normal driving energy for performing ejection driving. In other words, the circulation driving of the second energy generating element may be driving with a weaker energy than the ejection driving of the first energy generating element. In a case where the driving energy for the second energy generating element is reduced, the size and the aspect ratio of the energy generating element can be adjusted accordingly.

### Recirculation Concentration

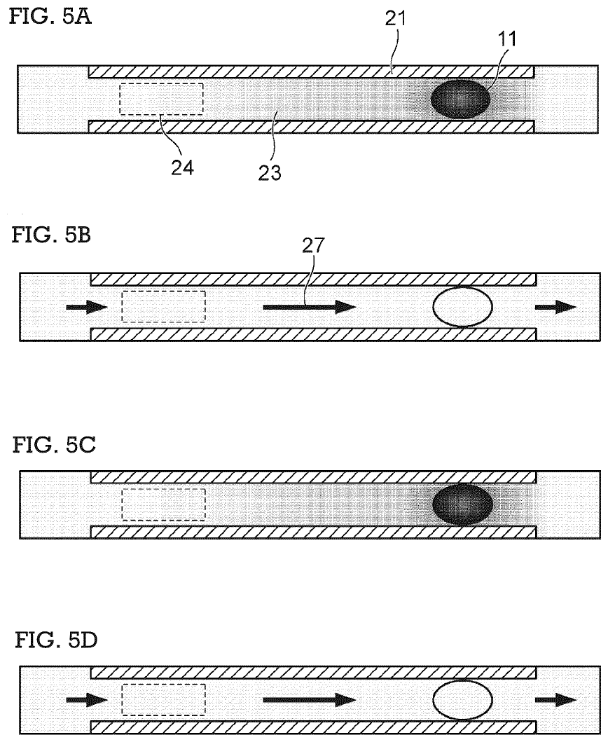

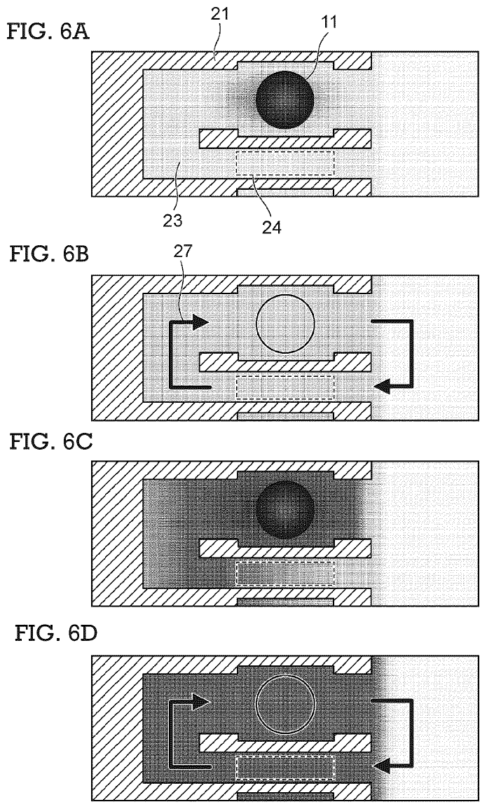

FIGS. 5A to 5D and FIGS. 6A to 6D are schematic views for explaining deconcentration accompanying the circulating flow of ink caused by the second energy generating element. FIGS. 5A to 5D show a straight-type configuration in which the inlet and the outlet of a circulating flow in the individual flow path are separated from each other. FIGS. 6A to 6D show a U-shaped configuration in which the inlet and the outlet of a circulating flow in the individual flow path are adjacent to each other. Note that the portion at which the ink has been concentrated is shown in a dark color, and the degrees of concentration are expressed by color gradation.

First, among FIGS. 5A to 5D, FIG. 5A illustrates a temporarily suspended state. During a temporary suspension, the volatile components evaporate from the ejection port portion, and concentration of the ink progresses in the vicinity of the ejection port. The state Immediately after a circulating flow is generated by the second energy generating element thereafter is illustrated in FIG. 5B. Concentration in the vicinity of the ejection port is eliminated by the circulating flow. The ink concentrated in the vicinity of the ejection port is discharged through the outlet, and concentration is eliminated in the entire individual flow path. A further temporarily suspended state after that is illustrated in FIG. 5C. Concentration of the ink progresses again in the vicinity of the ejection port as in FIG. 5A. The state immediately after a circulating flow is further generated by the second energy generating element thereafter is illustrated in FIG. 5D. Concentration in the vicinity of the ejection port is again eliminated, and concentration is also eliminated in the entire individual flow path, as in FIG. 5B. As described above, in the straight-type configuration in which the inlet and the outlet of the individual flow path are separated from each other, the concentrated state is reset each time a temporary suspension and a circulating operation are repeated.

On the other hand, among FIGS. 6A to 6D, FIG. 6A illustrates a temporarily suspended state. During the temporary suspension, concentration of ink progresses in the vicinity of the ejection port as in FIG. 5A. The state immediately after a circulating flow is generated by the second energy generating element thereafter is illustrated in FIG. 6B. Since the inlet and the outlet of the individual flow path are adjacent to each other herein, the ink concentrated in the vicinity of the ejection port is discharged through the outlet, but flows in again through the inlet. This replaces the ink in the entire individual flow path with a slightly concentrated ink, instead of a fresh ink (this will be hereinafter referred to as recirculation concentration). A further temporarily suspended state after that is illustrated in FIG. 6C. At this point of time, in addition to the state illustrated in FIG. 6B, concentration of the ink progresses again in the vicinity of the ejection port as described above with reference to FIG. 6A. The state immediately after a circulating flow is further generated by the second energy generating element thereafter is illustrated in FIG. 6D. At this point of time, the ink in the entire individual flow path is replaced with the concentrated ink even more than in FIG. 6B due to the influence of the recirculation concentration, as described above with reference to FIG. 6B. As described above, in the U-shaped configuration in which the inlet and the outlet of the individual flow path are adjacent to each other, the concentrated state is not reset every time a temporary suspension and a circulating operation are repeated. Instead, concentration gradually progresses in the entire individual flow path, and the concentrated state is worsened. Here, even in a case where the circulating operation is not repeated, if the ink in the vicinity of the ejection port is greatly concentrated due to a long suspension time or the like, the concentrated state is hardly alleviated even by the first circulating operation. This is because the recirculation concentration is hardly effective in alleviating the concentrated state.

Accordingly, between the straight-type configuration in which the inlet and the outlet of the individual flow path are separated from each other, and the U-shaped configuration in which the inlet and the outlet of the individual flow path are adjacent to each other, there is a difference in the concentration eliminated state caused by a temporary suspension and a circulating operation, due to the difference in the influence of the discharged concentrated ink. In the straight-type configuration, the concentrated state in the entire individual flow path is easily eliminated, and thus, the ejection stability is hardly degraded by a concentrated ink. In the U-shaped configuration, on the other hand, the concentrated state in the entire individual flow path is difficult to eliminate due to the recirculation concentration, and therefore, ejection is likely to become unstable depending on the concentration in the entire individual flow path.

### Ink

As described so far, the degree of concentration elimination differs depending on the difference in the flow path configuration. However, it is possible to reduce the influence of concentrated ink having its viscosity increased by evaporation at the ejection port, by generating an ink circulating flow in the individual flow path with the second energy generating element. That is, as the ink ejected state can be maintained well, influences of a change in ejection speed or the like can be reduced, and ejection is easily stabilized.

On the other hand, it is assumed that inks that have different types of color materials or differ in solid content are used depending on the purpose of use of a liquid ejection head and a liquid ejection device equipped with the head. That is, it is preferable for a liquid ejection head to maintain a high-level ejection stability even if any kind of ink is used. For example, it is conceivable to use an ink with a reduced moisture content to counter a problem that might occur due to the moisture in the ink, such as curling (warping) and cockling (wavy wrinkles) in plain paper. Since the concentration of solids such as an organic solvent, a pigment, and a resin other than moisture becomes higher in an ink having a low moisture content, the viscosity of the ink is liable to increase rapidly with moisture evaporation, leading to a decrease in ink ejection stability. For such an ink, a method for generating a circulating flow in a pressure chamber as in the present disclosure is particularly effective, because it can reduce the increase in the viscosity of the ink. Normally, an ink having a high solid content exhibits a solid content of 10 wt %. That is, the present disclosure is preferably applied to an ink having a solid content of 10 wt % (mass %) or higher in the ink.

Further, regarding the temperature at which a head is operated, the head may be used at a temperature heated to a constant temperature by disposing and controlling a heater in the entire chip. Since ink viscosity varies depending on temperature, the ink viscosity at the head operating temperature affects ejection stability.

In a case where a circulating flow is formed by the second energy generating element, the value of the circulating flow velocity can be several tens of mm/s to 1000 mm/s in instantaneous flow velocity. The average flow rate as seen in terms of time width on the order of several hundreds of microseconds depends on the drive frequency of the circulating heater. This is because, in the case of a circulating heater, the circulating flow is a transient circulating flow that attenuates over time and stops after a certain period of time. In a case where driving is performed at a frequency of about 10 to 20 kHz, which is almost the same as the drive frequency (ejection frequency) of the first energy generating element, the average flow velocity can be several mm/s to 100 mm/s.

In a case where an ink having a high pigment concentration, such as an ink having such a concentration that the viscosity at the head operating temperature is at least 3 cP (Centipoise) and not more than 6 cP, is used, for example, the viscosity of the ink is liable to increase at the ejection port portion, depending on the non-ejection time (suspension time). Therefore, a change in ejection speed is likely to occur, and ejection stability is likely to drop. In view of this, it is possible to cause ink circulation while the suspension time is short, and to eliminate concentration by causing steady ink circulation or transient ink circulation at high frequency. In a case where a circulating heater is used as the second energy generating element, transient ink circulation is caused. Therefore, a circulating operation is performed at high frequency, to contribute to elimination of concentration at the ejection port portion.

On the other hand, in a case where an ink having a low pigment concentration, such as an ink having such a concentration that the viscosity at a head operating temperature is at least 1 cP and not more than 2 cP, is used, for example, a change in ejection speed might occur depending on the non-ejection time (suspension time), but its influence is relatively small compared with that in a high-concentration ink. In a case where the suspension time is long, the viscosity of the ink becomes higher at the ejection port portion, depending on the non-printing drive time (stop time), for example. Therefore, at a time of restarting after stopping without printing over a certain period of time, it is possible to perform recovery processing with waste ink, such as a suction operation, a wiping operation, and preliminary ejection in conjunction with these operations. In a case where a circulating heater is used as the second energy generating element, a circulating flow is formed, and a recovery operation is performed. Thus, it is possible to contribute to elimination of concentration at the ejection port portion without generating any waste ink. Depending on the stop time, it is also possible to prevent waste ink from being generated by the recovery processing involving only a circulating operation. Alternatively, recovery processing can be performed to minimize waste ink by partially combining a suction operation for removing bubbles in the head but not for elimination of concentration, while recovering by performing a circulating operation.

It is desirable for both a high-concentration ink and a low-concentration ink to return to the initial fresh ink as much as possible to reduce the influence of a concentrated ink. Therefore, even in a case where a circulating heater is used as the second energy generating element, a greater circulation effect can be achieved when the influence of recirculation concentration is smaller. That is, a straight-type configuration provides a greater effect than a U-shaped configuration.

### First Embodiment

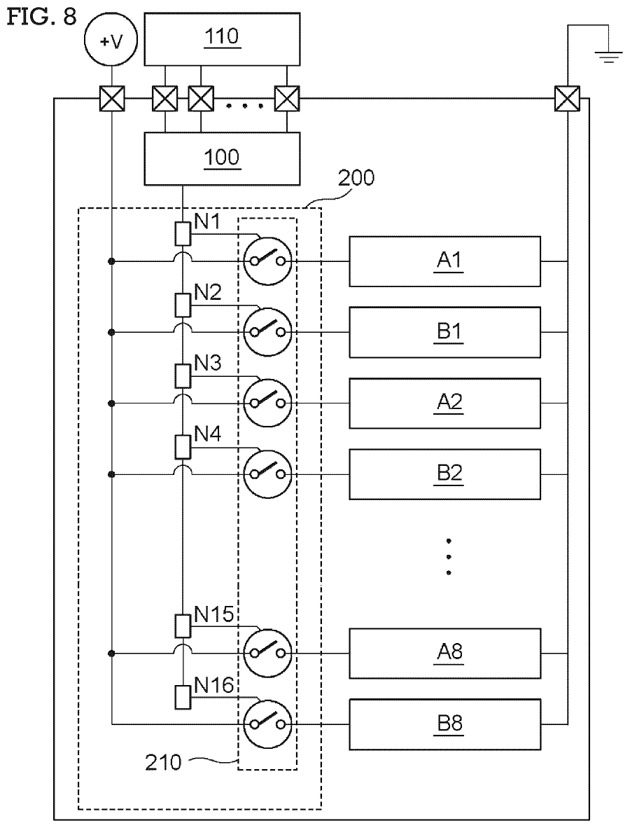

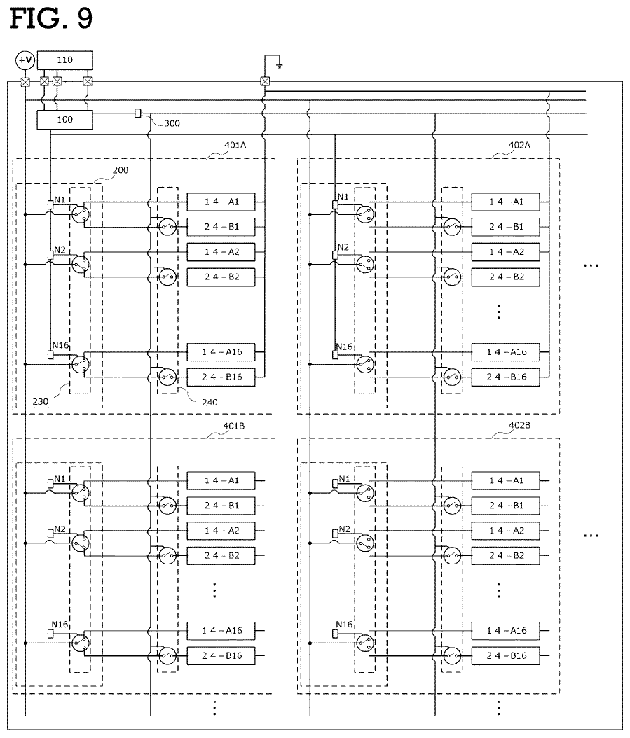

FIGS. 7A to 7C are schematic views for explaining in detail the vicinities of ejection ports of a liquid ejection head that ejects liquid such as ink in the first embodiment. FIG. 7A is a plan view as viewed in the direction in which droplets are ejected from the ejection ports. FIG. 7B is a cross-sectional view of the structure taken along the line A-B defined in FIG. 7A. FIG. 7C is an enlarged schematic view for explaining the element names in the individual flow path portions in FIG. 7A. FIG. 8 is a block diagram for explaining the configuration of a selective drive circuit on a substrate in a comparative configuration, and FIG. 9 is a block diagram for explaining the configuration of a selective drive circuit on a substrate in this embodiment.

In FIGS. 7A and 7B, an ejection port 11 for ejecting liquid is formed in an orifice plate 19. A first energy generating element 14 is formed immediately below the ejection port 11 in a substrate 18. In addition to the first energy generating element 14, a second energy generating element 24 is formed in the substrate 18 in a similar manner, and a circulating flow 27 is formed in an individual flow path 23. Liquid is supplied from a supply groove 42 to the individual flow path 23 including the ejection port 11. At this point of time, both ends of the individual flow path are adjacent to each other in a first direction in which the ejection ports are arranged.

Here, in a system that is called a U-shaped configuration because of the shape of the flow path shown in FIG. 7A, both ends of the individual flow path are adjacent to each other in the first direction in which the ejection ports are arranged. The names of the respective elements that are used in FIGS. 8 and 9 are now described. As shown in FIG. 7C, each individual flow path 23 includes a first energy generating element 14 and a second energy generating element 24. To distinguish each of the elements, the first energy generating elements are represented by Ai (i=1, 2, 3, . . . , n), and the second energy generating elements are represented by Bi (i=1, 2, 3, . . . , n). In this case, for example, A1 and B1 indicate that the corresponding elements are in the same individual flow path.

### Drive Method for Comparative Configuration

In a comparative configuration, a selective drive circuit 200 as shown in FIG. 8 is formed on a substrate 18. A voltage source (+V) and a controller 110 as a control unit are provided outside the substrate, and are connected to the selective drive circuit 200 on the substrate 18. The selective drive circuit 200 includes an on-off drive circuit (on-off changeover switch) 210.

The on-off drive circuit 210 drives each of the first energy generating elements (A1 to A8) or the second energy generating elements (B1 to B8) in an on-state or an off-state, in response to a control signal at each address (N1 to N16 in this configuration) received from a control data supply circuit 100. That is, each of the first energy generating elements and the second energy generating elements is controlled independently from the others by a switch designed to be capable of switching the elements between a drivable state and an undrivable state. Here, the control data supply circuit 100 controls a drive pulse for driving a first energy generating element or a second energy generating element, and time intervals at which the drive pulse is applied to each element.

In the comparative configuration, the first energy generating elements and the second energy generating elements are associated with different addresses, and drive circuits are provided separately. Therefore, it is possible to provide drive data for each of the first energy generating elements and the second energy generating elements. Accordingly, the amount of data increases with the total number of elements that are the first energy generating elements and the second energy generating elements.

### First Drive Method of the Embodiment

In a first drive configuration in this embodiment, a selective drive circuit 200 as shown in FIG. 9 is formed on a substrate 18. A voltage source (+V) and a controller 110 are provided outside the substrate, and are connected to the selective drive circuit 200 on the substrate 18. The selective drive circuit 200 includes an on-on drive circuit 230 (a first switch for performing switching on-on).

The on-on drive circuit 230 turns on and drives one of the first energy generating elements (A1 to A16) and the second energy generating elements (B1 to B16), in response to a control signal at each address (N1 to N16 in this embodiment) received from a control data supply circuit 100. That is, the on-on drive circuit 230 includes a switch designed to be capable of exclusively switching the first energy generating elements and the second energy generating elements so that only one of them enters a drivable state. By this switch, the second energy generating elements are always in an undrivable state when the first energy generating elements are in a drivable state. Conversely, the first energy generating elements are always in an undrivable state when the second energy generating elements are in a drivable state.

Here, the control data supply circuit 100 controls a drive pulse for driving a first energy generating element or a second energy generating element, and the time intervals at which the drive pulse is applied to each element.

In the drawings, first energy generating element groups 401 and second energy generating element groups 402 collectively represent the first energy generating elements 14 and the second energy generating elements 24, respectively. Reference signs 401A and 401B indicate different first energy generating element groups 401. Reference numerals 402A and 402B indicate different second energy generating element groups 402. Further, in the drawing, for example, “14-A1” represents the “first energy generating element A1”, and “24-B1” represents the “second energy generating element B1”.

The selective drive circuit 200 further includes an on-off drive circuit 240 (a second switch for performing switching on-off) for the second energy generating elements. The on-off drive circuit 240 controls driving of the second energy generating elements in accordance with a drive enable/disable signal 300 for the second energy generating elements, even when the second energy generating element side is selected by the on-on drive circuit 230. That is, the second energy generating elements are further controlled by a switch designed to be capable of switching the second energy generating elements between a drivable state and an undrivable state.

Accordingly, in a case where the first energy generating elements are in an undrivable state, the second energy generating elements are in a drivable state, but are actually driven only when a drive signal (drive enable/disable signal) for issuing an instruction to drive the second energy generating elements. In a case where the drive enable/disable signal has not been received, any of the second energy generating elements is not driven even if the second energy generating element side is selected by the on-on drive circuit 230. That is, at this point of time, neither the first energy generating elements nor the second energy generating elements are driven. Here, as the first drive circuit in this embodiment, a common drive enable/disable signal is used for all of the second energy generating elements.

To sum up, in this embodiment, a drive circuit for controlling driving of the first energy generating elements and the second energy generating elements includes a first switch designed to be capable of exclusively switching the first energy generating elements and the second energy generating element so that only one of the elements enters a drivable state, and a second switch designed to be capable of switching the second energy generating elements between a drivable state and an undrivable state. As the drive circuit is used, the first energy generating elements and the second energy generating elements are characteristically driven and controlled under the following conditions:

Conditions: In a case where a first energy generating element is driven, the second energy generating elements are not driven. In a case where the first energy generating elements are not driven, a second energy generating element is driven when a drive signal for issuing an instruction to drive the second energy generating element is received.

Further, it is preferable that the on-off drive circuit (second switch) is disposed closer to the second energy generating elements with respect to the on-on drive circuit (first switch), and is disposed electrically on the downstream side with respect to the second energy generating elements. It is also preferable to drive and control a plurality of second energy generating elements, using a common drive signal.

As a comparison, measures against increased viscosity of ink in a liquid ejection head that does not form a circulating flow is described herein. The measures include a preliminary ejecting operation for ejecting ink through the ejection port, and a suction operation for sucking ink from through ejection port. For example, in a serial liquid ejection device, a preliminary ejecting operation or a suction operation is performed before the device moves on to a printing operation away from the cap protecting the head at the head standby position. Alternatively, a preliminary ejecting operation is performed in a non-printing region out of the printing medium when reciprocating movement is conducted by the carriage in a printing operation. These are different timings from those in a printing operation. Further, in the case of an ink that is liable to have an increased viscosity, a preliminary ejecting operation may be performed in addition to a printing operation to such an extent that any image influence does not appear on the printing medium in the printing region when reciprocating movement is conducted.

In this embodiment, a circulating operation is performed by driving a second energy generating element, so that the number of times a preliminary ejecting operation or a suction operation is performed can be reduced. In this case, the timing of a circulating operation in a non-printing region at the head standby position or during reciprocating movement is also different from the timing of a printing operation. Therefore, in this embodiment, driving of the second energy generating elements can be easily controlled by the drive enable/disable signal 300 for the second energy generating elements. In the case of ink having viscosity that easily increases, during a circulating operation in the printing region with reciprocating movement, it is possible to put priority on the ejecting operation at a timing close to the printing operation. On the other hand, a plurality of timings is provided for circulating operations, or a certain period of time is provided for a circulating operation, to eliminate the need to perform a circulating operation and a printing operation at the same time. Therefore, in this embodiment, when the first energy generating element side is selected, the first energy generating elements are driven. Thus, the circulating operation can be controlled as appropriate, without affecting the printing operation.

As described so far, the second energy generating elements are driven and controlled in accordance with drive data and the drive enable/disable signal for the first energy generating elements. This eliminates the need to provide drive data for the second energy generating elements, which leads to the advantage that the amount of drive data can be reduced accordingly.

Furthermore, in a case where there is a plurality of second energy generating elements, drive control can be performed, on the basis of a common drive enable/disable signal. In this embodiment, the first energy generating elements Ai and the second energy generating elements Bi are controlled as a group of a total of 32 elements (16 pairs), with n being 16 at a maximum. However, the total number of elements in one group may be any appropriate value such as 16 (eight pairs) or 24 (12 pairs).

Although electro-thermal conversion elements or piezo elements can be used as the second energy generating elements, the direction of a circulating flow in a case with electro-thermal conversion elements has been described in this embodiment. In a case with piezo elements, a circulating flow might be opposite to that of the above-described embodiment, depending on the drive method.

In this embodiment, the drive enable/disable signal 300 is provided in the substrate 18, to control driving of the second energy generating elements. However, the drive enable/disable signal 300 may be provided in a liquid ejection head outside the substrate, or in a liquid ejection device outside the liquid ejection head, to control driving of the second energy generating elements.

### Second Drive Method of the Embodiment

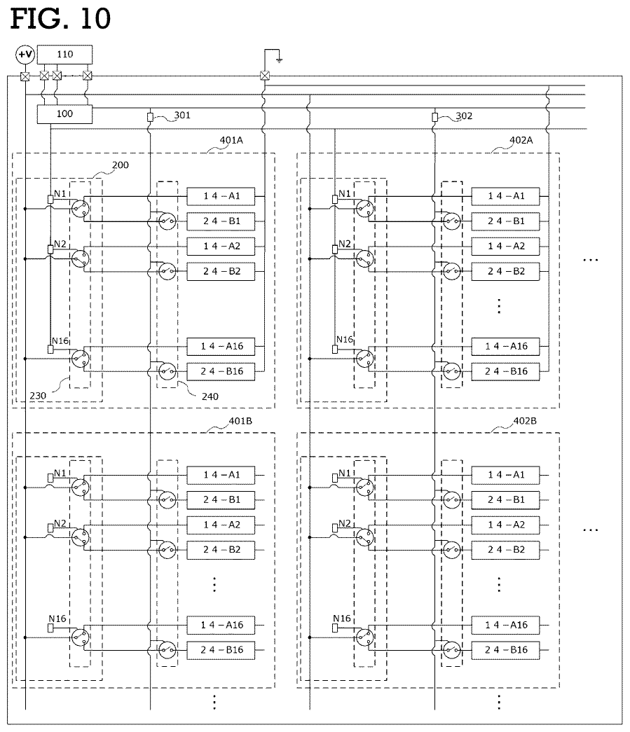

FIG. 10 is a block diagram for explaining the configuration of a selective drive circuit on a substrate in a second drive configuration in this embodiment. Here, a plurality of individual ejection unit groups is suggested. Each individual ejection unit group includes a plurality of individual ejection units. An instruction for the second energy generating elements 24 is issued for each individual ejection unit group in accordance with a drive signal.

This embodiment differs from the first drive method in that a plurality of common drive enable/disable signals 300 is provided as a first drive enable/disable signal 301 and a second drive enable/disable signal 302. In this embodiment, a plurality of drive enable/disable signals is provided for each array. Here, a first energy generating element group 401 and a second energy generating element group 402 mean different rows. Note that the number of arrays can be applied to a plurality of rows including two or more rows. Each of the first energy generating element group 401 and the second energy generating element group 402 is an energy generating element group included in a plurality of individual ejection units arranged in an array direction.

Advantages of this configuration include an instantaneous power reduction and power averaging by a reduction in total number of second energy generating elements to be driven. Here, by the first drive method, the second energy generating elements are controlled with a common drive enable/disable signal. In a case where all the first energy generating elements are not being driven when the common drive enable/disable signal is received, all the second energy generating elements are driven. In this manner, in a case where the first energy generating elements are hardly driven, the number of the second energy generating elements to be driven increases accordingly, which uses more electric power.

By the second drive method, on the other hand, a plurality of drive enable/disable signals is provided for each column, and thus, the number of second energy generating elements can be reduced. Here, in particular, in a circulating operation using the second energy generating elements in a non-printing region, power is used because the first energy generating elements are not driven. Further, since the timing is different from that for the printing operation, the power is distributed to operations other than the printing operation, such as paper transportation. Therefore, there is a power limitation different from that in the printing region, and a power reduction is used. Therefore, a drive enable/disable signal is provided for each row to reduce the number of second energy generating elements to be driven, and thus, an instantaneous power reduction and power averaging can be achieved.

The same applies in a case where a plurality of colors is provided in the same chip, and in a case where a drive enable/disable signal is provided for each color, instead of each row. In a case where a pigment ink, a dye ink, and the like are provided as a plurality of inks in the same color, these inks are distinguished as different colors from one another, and a drive enable/disable signal is also provided for each of the colors. As a drive enable/disable signal is provided for each color, electric power can be reduced as in a case where a drive enable/disable signal is provided for each row. Furthermore, in a case where only a specific color is used as in the case of a black-and-white printing mode, for example, it is possible to reduce electric power by providing a drive enable/disable signal for only the ink in the specific color.

Note that, when drive enable/disable signals for the respective rows or the respective colors are generated, a plurality of drive enable/disable signals may be supplied from outside the chip, or a signal may be divided into a plurality of signals in the chip.

### Third Drive Method of the Embodiment

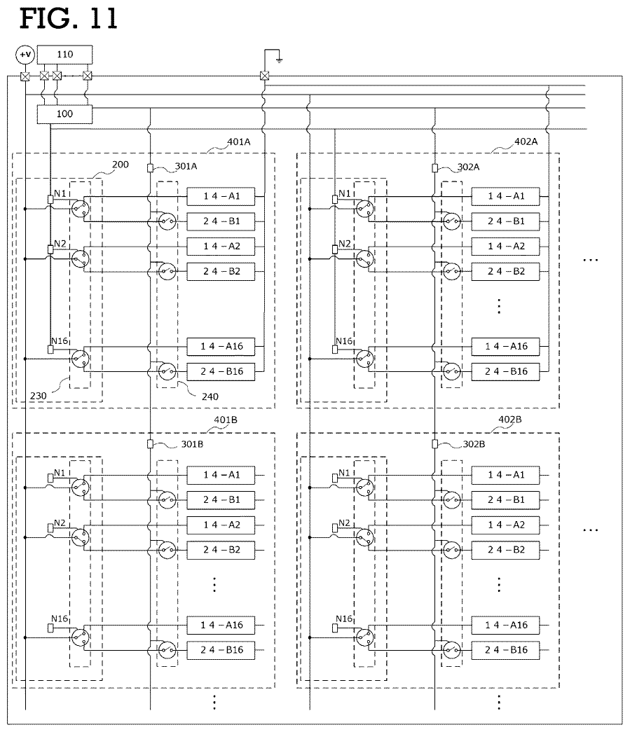

FIG. 11 is a block diagram for explaining the configuration of a selective drive circuit on a substrate in a third drive configuration in this embodiment. Here, a plurality of individual ejection unit groups is also suggested.

This method differs from the first drive method and the second drive method in that a plurality of drive enable/disable signals 301 and 302 for the respective rows is provided as drive enable/disable signals 301A, . . . , and 302A, . . . , in the rows. By this method, a plurality of drive enable/disable signals is provided for each block in the rows. Note that the same applies to a plurality of rows in which drive enable/disable signals are provided for the respective blocks in a plurality of blocks.

Advantages of this configuration include an instantaneous power reduction and power averaging by a further reduction in total number of second energy generating elements to be driven. In particular, in a case where the first energy generating elements are hardly driven or are not driven in a non-printing region, the number of second energy generating elements to be driven can be reduced as in the case with the second drive method. Electric power can be further reduced, because of the drive enable/disable signals for the respective blocks, instead of drive enable/disable signals for the respective rows. Furthermore, in a case where part of a row, not an entire row, is a non-printing region, the electric power for the corresponding second energy generating elements can be reduced accordingly. For example, in a serial liquid ejection device, part of a row might be a non-printing region in the initial scan at the start of printing on a recording medium or in the final scan at the end of printing. In a case where a circulating operation using second energy generating elements is performed for each scanning operation, the electric power can be reduced accordingly. Further, in a page-wide liquid ejection device, the printing width changes with the printing size, and therefore, part of a row might be a non-printing region. In that case, printing can be performed without a circulating operation using second energy generating elements, and thus, electric power can be reduced accordingly.

### Second Embodiment

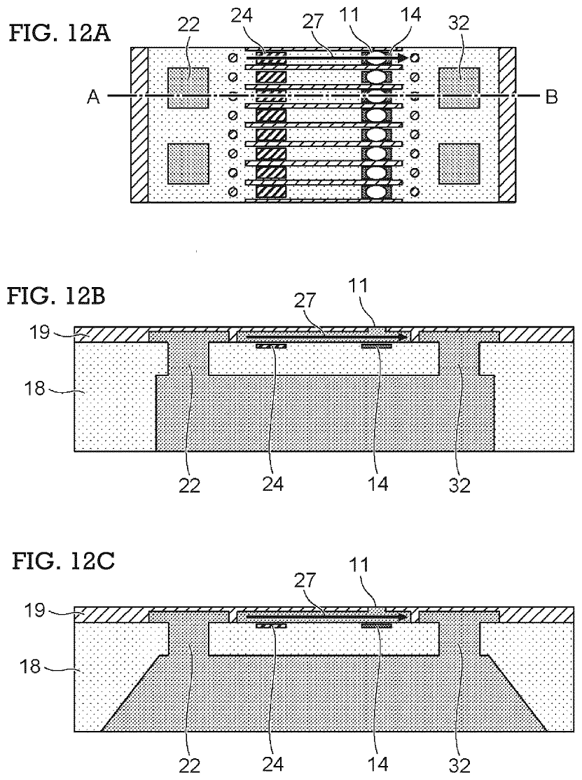

FIGS. 12A to 12C are schematic views for explaining in detail the vicinities of ejection ports of a liquid ejection head that ejects liquid such as ink in a second embodiment. FIG. 12A is a plan view as viewed in the direction in which droplets are ejected from the ejection ports. FIGS. 12B and 12C are two examples of a cross-sectional view taken along the line A-B defined in FIG. 12A.

Here, FIGS. 12B and 12C illustrate two examples in which the shape of the back side of the substrate varies depending on the type of the etching method adopted for the substrate, and the back side of the substrate may have either of the shapes as its cross-sectional shape.

This embodiment differs from the first embodiment in being a straight-type configuration in which the inlet and the outlet of each individual flow path are separated from each other. In this embodiment, both ends of each individual flow path are located separately at positions opposite to a second direction orthogonal to a first direction in which the ejection ports are arranged.

Advantages of this configuration include a reduction in influence of concentration, because the inflow and the outflow of each circulating flow are separated in opposite directions, and the ink concentrated at the ejection ports does not flow back into the individual flow paths with circulation.

### Third Embodiment

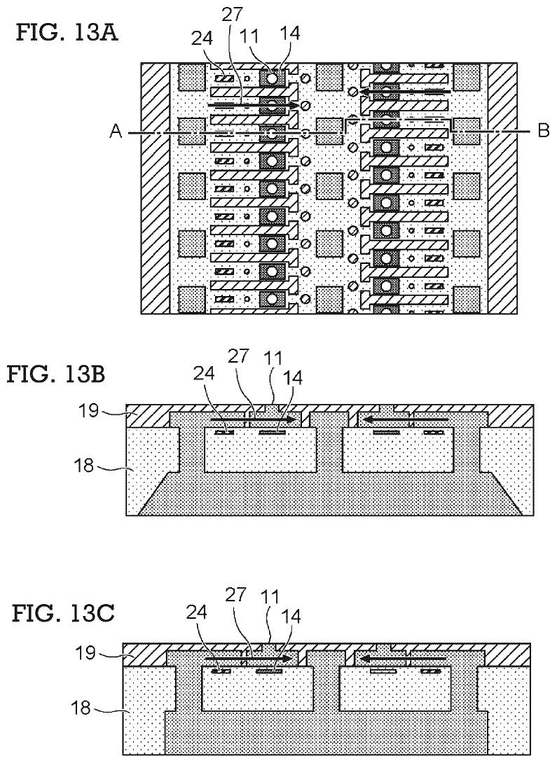

FIGS. 13A to 13C are schematic views for explaining in detail the vicinities of ejection ports of a liquid ejection head that ejects liquid such as ink in a third embodiment. FIG. 13A is a plan view as viewed in the direction in which droplets are ejected from the ejection ports. Like FIGS. 12B and 12C, FIGS. 13B and 13C are two examples of a cross-sectional view taken along the line A-B defined in FIG. 13A.

This embodiment differs from the second embodiment in that three supply opening rows are provided to double the ejection port rows, and ejection port rows are provided on the side closer to the center supply opening row. That is, ejection port rows are formed on both sides in the array direction in which a plurality of supply openings is arranged. The ejection port rows are arrays of ejection ports 11 included in the rows in which a plurality of individual ejection units is arranged. That is, two rows are disposed in parallel on the right and left, along the center supply opening row. Here, the center opening row that is shared by a first row and a second row is a second opening row in which second openings are arranged. Further, the opening row at an end portion provided for each of the first unit row and the second unit row is a first opening row in which first openings are arranged.

One of the advantages of this configuration lies in that an ejection port row can be doubled from one row to two rows by increasing the supply openings from two rows to three rows. It is also possible to arrange two ejection port rows with the pitch shifted as shown in the drawing. Further, it is possible to adopt a configuration in which any wiring region is not required between the openings in the center supply opening row, and the degree of freedom is high in the size and resolution of the openings in the center supply opening row. Because of this, the speed of refilling the nozzles is increased, and it is easy to cope with high productivity.

Although the three supply opening rows are arranged at the same position in terms of the direction between the nozzle rows in this embodiment, the three rows may be shifted from one another depending on the positions of the nozzles and extensions of wiring lines between the openings in each row. This also applies in the following embodiments.

### Fourth Embodiment

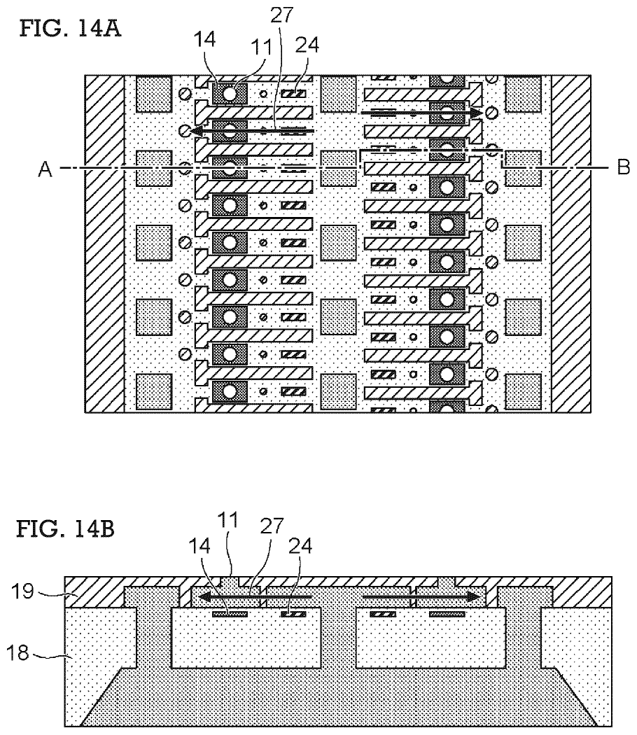

FIGS. 14A and 14B are schematic views for explaining in detail the vicinities of ejection ports of a liquid ejection head that ejects liquid such as ink in a fourth embodiment. FIG. 14A is a plan view as viewed in the direction in which droplets are ejected from the ejection ports. FIG. 14B is a cross-sectional view of the structure taken along the line A-B defined in FIG. 14A.

This embodiment differs from the third embodiment in that the direction of the circulating flow is reversed, because the ejection port rows are provided on the sides near the supply opening rows on both sides, and the second energy generating elements are provided on the side near the center supply opening row.

One of the advantages of this configuration lies in that the ink concentrated in the vicinity of an ejection port is branched into the supply opening rows on both sides and is then discharged, and thus, the influence of the concentrated ink when the ink flows back into the individual flow path due to ejection or the like is reduced. Further, since the ejection port rows are disposed apart from each other, the influence of interference caused by the meniscus oscillation accompanying the ejection from each ejection port can be reduced.

### Fifth Embodiment

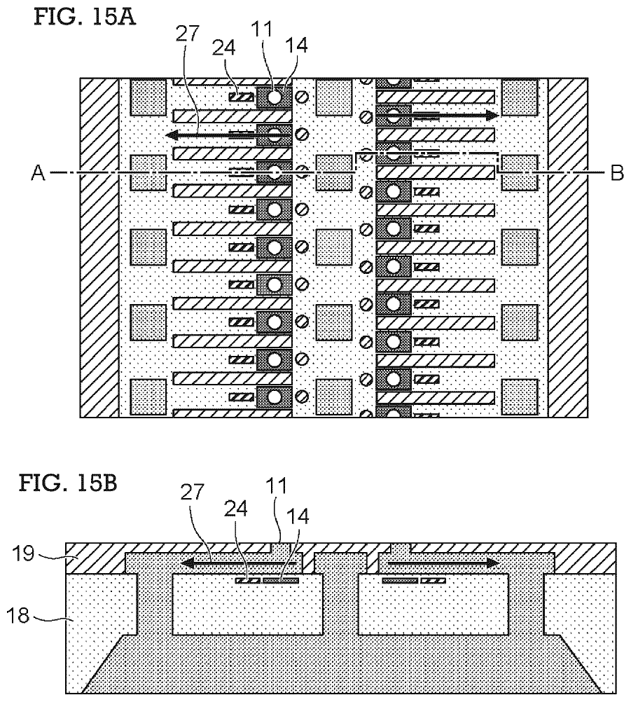

FIGS. 15A and 15B are schematic views for explaining in detail the vicinities of ejection ports of a liquid ejection head that ejects liquid such as ink in a fifth embodiment. FIG. 15A is a plan view as viewed in the direction in which droplets are ejected from the ejection ports. FIG. 15B is a cross-sectional view of the structure taken along the line A-B defined in FIG. 15A.

This embodiment differs from the third embodiment in that the direction of the circulating flow is reversed, because the second energy generating elements are located close to the first energy generating elements, and the second energy generating elements are closer to the center supply opening row than to the supply openings on both sides.

Some of the advantages of this configuration lie in that refilling can be performed more quickly to cope with high productivity because the degree of freedom in the size and the resolution of the center supply opening row is high as in the third embodiment, and that the influence of concentrated ink when the ink flows back into the individual flow path after ejection or the like is reduced because the ink concentrated in the vicinity of the ejection port is branched into the supply opening rows on both sides and is then discharged.

### Sixth Embodiment

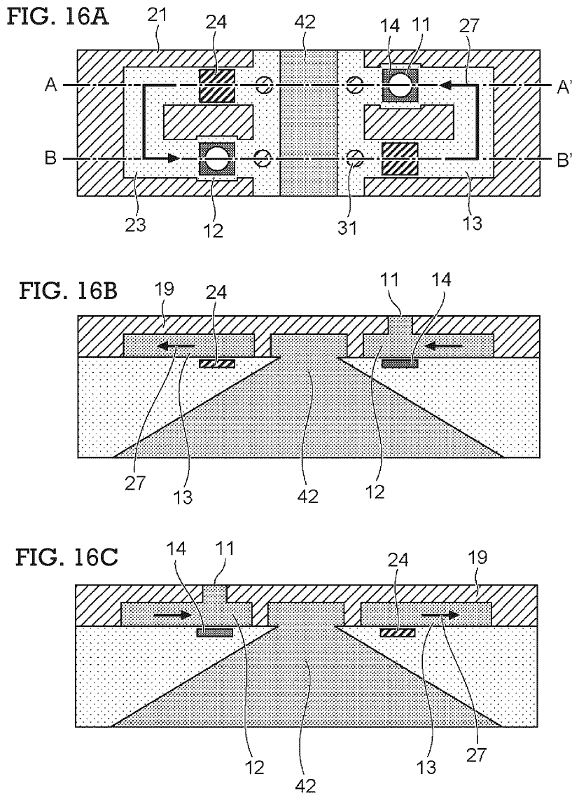

FIGS. 16A to 16C are schematic views for explaining in detail the vicinities of ejection ports of a liquid ejection head that ejects liquid such as ink in a sixth embodiment. FIG. 16A is a plan view as viewed in the direction in which droplets are ejected from the ejection ports. FIGS. 16B and 16C are cross-sectional views of the structure taken along the line A-A′ and B-B′ defined in FIG. 16A, respectively.

This embodiment differs from the first embodiment in that the left and right ejection port rows sandwiching a supply groove are arranged in a staggered manner, and that a filter is also provided at the inlet of each individual flow path (in the vicinity of the corresponding second energy generating element). In such a configuration, the effects of the present disclosure can also be achieved.

According to the present disclosure, it is possible to provide a technology for optimizing the amount of drive data in an ink-circulating liquid ejection head using both an ejection energy generating element and a flow energy generating element.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-150032, filed Aug. 30, 2024, which is hereby incorporated by reference herein in its entirety.

What is claimed is:

1. A liquid ejection head comprising:
an individual ejection unit including,
an ejection port for ejecting a liquid,
a pressure chamber communicating with the ejection port,
a first energy generating element provided in the pressure chamber, and generating energy for ejecting the liquid from the ejection port,
an individual flow path communicating with the pressure chamber, and
a second energy generating element provided in the individual flow path; and
a common flow path for supplying the liquid to the individual flow paths of a plurality of the individual ejection units, wherein
when the first energy generating element is driven, the second energy generating element is not driven, and, when the first energy generating element is not driven, the second energy generating element is driven only after receiving a drive signal for issuing an instruction to drive the second energy generating element.

2. The liquid ejection head according to claim 1, wherein
when the plurality of individual ejection units is divided into a plurality of individual ejection unit groups, driving of the first energy generating element and the second energy generating element is controlled for each of the individual ejection unit groups, and
the drive signal for issuing the instruction to drive the second energy generating element is a signal of instruction issued for each of the individual ejection unit groups.

3. The liquid ejection head according to claim 2, wherein each of the plurality of individual ejection unit groups is a row in which the plurality of individual ejection units is arranged in an array direction.

4. The liquid ejection head according to claim 3, wherein each of the plurality of individual ejection unit groups includes a plurality of the rows.

5. The liquid ejection head according to claim 2, wherein each of the plurality of individual ejection unit groups is a block including the plurality of individual ejection units.

6. The liquid ejection head according to claim 2, wherein the plurality of individual ejection unit groups respectively corresponds to the individual ejection units that eject the liquid of different colors.

7. The liquid ejection head according to claim 1, wherein a plurality of the ejection ports included in the plurality of the individual ejection units forms an ejection port row.

8. The liquid ejection head according to claim 7, wherein, in the individual flow path of the individual ejection unit, the first energy generating element and the second energy generating element are arranged in a direction intersecting the ejection port row.

9. The liquid ejection head according to claim 8, wherein the individual flow path extends in a direction intersecting the ejection port row so that both end portions of the individual flow path are positioned, with the ejection port row being interposed between the end portions.

10. The liquid ejection head according to claim 7, wherein
the plurality of individual flow paths of the plurality of individual ejection units is connected to the common flow path via a first opening and a second opening, and
the first opening and the second opening are each arranged along the ejection port row, so as to form a first opening row and a second opening row.

11. The liquid ejection head according to claim 10, wherein
the plurality of individual ejection unit groups, in which the plurality of the individual ejection units is arranged, is provided in parallel,
the second opening row is provided between the plurality of individual ejection unit groups, and is shared by the plurality of individual ejection unit groups, and
the first opening row is provided for each of the plurality of individual ejection unit groups.

12. The liquid ejection head according to claim 11, wherein the first energy generating element is disposed on a side, which is close to the second opening, of the individual flow path.

13. The liquid ejection head according to claim 11, wherein the second energy generating element is disposed on a side, which is close to the second opening, of the individual flow path.

14. The liquid ejection head according to claim 7, wherein, in the individual flow path, the first energy generating element and the second energy generating element are arranged along the ejection port row.

15. The liquid ejection head according to claim 14, wherein the individual flow path has both end portions located on one side of the ejection port row.

16. The liquid ejection head according to claim 1, wherein the second energy generating element performs circulation driving for circulating the liquid in the individual flow path, and the first energy generating element performs ejection driving for ejecting the liquid from the ejection port.

17. The liquid ejection head according to claim 16, wherein the circulation driving is driving with weaker energy than that of the ejection driving.
